(19) United States
(12) Patent Application Publication
(10) Pub. No.: US 2025/0252013 A1
(43) Pub. Date: Aug. 7, 2025

(54) Efficient Error Detection Code

(71) Applicant: Graphcore Limited, Bristol (GB)

(72) Inventor: Stephen FELIX, Bristol (GB)

(21) Appl. No.: 19/043,921

(22) Filed: Feb. 3, 2025

(30) Foreign Application Priority Data
Feb. 7, 2024 (GB) 2401615.6

(51) Int. Cl. G06F 11/10

(52) U.S. Cl. CPC G06F 11/1016; G06F 11/1004; G06F 11/1068

(57) ABSTRACT

A device comprising circuitry for determining a plurality of error detection bits for data to be written and read from a memory device over a plurality of wires. The plurality of error detection bits are determined in accordance with a code comprising a plurality of parts, each of which identify which bits of the message data are for use in calculating its associated error detection bits, and represent a rotation of another one of the parts of the code by the number of wires. Determining each error detection bit comprises performing XOR operations between the bits of the message data identified by the code. The circuity is configured to cause each of a plurality of subsets of the message data to be sent to the memory device over a different one of the plurality of wires; and cause the error detection bits to be sent to the memory device.

### CROSS-REFERENCE TO RELATED APPLICATIONS

The present application claims priority to United Kingdom Patent Application No. GB2401615.6, filed Feb. 7, 2024, the disclosure of which is hereby incorporated herein by reference in its entirety.

### TECHNICAL FIELD

The present application is related to a device comprising circuitry for interfacing with a memory device and in particular to a device comprising circuitry for determining a plurality of error detection bits for data to be written to the memory device and data read from the memory device.

### BACKGROUND

Memory devices are used to store data for later retrieval and use in applications. However, the processes of writing, storing, and retrieving the data from such memory devices can expose the data to sources of error that can cause the values of the data to change.

There are two different types of error that commonly occur in memory, these being random errors and hardware errors. Random errors result from ionising radiation that causes the content of memory cells to change. Such ionising radiation may cause the value of a bit stored in a memory cell to flip from a ‘1’ to a ‘0’ or vis versa. The ionising radiation may be received from sources external to a memory device or may be emitted by the materials used to package electronics. Random errors are rare, but can be problematic, since it is not possible to predict whether a random error will occur in any particular bit of data.

Hardware errors, which are more predictable, could result from numerous different sources. The errors could affect regions of the memory device or individual wires of the memory device. Some examples of sources of hardware errors include: clock signal timing errors, noise on a bus for transporting data, entire regions of the memory device becoming faulty due to aging, dirty connections of the memory device, and dry soldier joints.

Error detection bits are used to detect errors in data sent over communication channels. Error detection bits are calculated by performing certain operations on a set of message data. The error detection bits are then sent along with the message data in a codeword. The error detection bits represent certain redundant information that allows for the detection of one or more errors that may be present in the message data.

One type of error detection code is a cyclic redundancy check (CRC) code. Each bit of the CRC check value is calculated by performing XOR operations between a large number of bits of the message data. A CRC for a set of message data provides for guaranteed detection of all 3-bit errors, and for guaranteed detection of any errors occurring within a burst of a predefined length (e.g., 16 bits in the case of a 16-bit CRC).

### SUMMARY

One of the considerations when designing a check code is the requirement to protect against a larger number of errors. One of the advantages of the CRC code is that, in addition to the guaranteed detection of 3-bit errors, burst errors within a burst of a certain length are guaranteed to be detected. However, one downside is the large number of XOR operations required to calculate the CRC check value. For instance, to calculate a 16-bit CRC check value over 256 bits of message data, it is required to perform XOR operations between 2078 different inputs. In this case, most of the bits of the CRC check value require more than 128 input bits to calculate, requiring a tree of XOR gates that is 8 gates deep in order to process each of the input bits. It is desirable to create a code that is more efficient and requires fewer XOR operations to implement, whilst still guaranteeing detection of any errors occurring within a burst of message data bits.

According to a first aspect, there is a device comprising circuitry for interfacing with a memory device over a plurality of wires, where the circuity is configured to: receive at least one write request comprising message data to be written to the memory device; and determine a plurality of error detection bits for the message data in accordance with a code, wherein the code comprises a plurality of parts each of which is associated with one of the error detection bits, wherein each of the parts of the code identifies which bits of the message data are for use in calculating its associated one of the error detection bits, wherein each of the parts of the code represents a rotation of another one of the parts of the code by a number of the plurality of the wires, wherein the determining the plurality of error detection bits comprises, for each of the error detection bits: performing XOR operations between the bits of the message data that are identified by the part of the code that is associated with the respective error detection bit, wherein the circuity is configured to: cause each of a plurality of the subsets of the message data to be written to the memory device over a different one of the plurality of wires; and cause the error detection bits to be written to the memory device.

The device is provided with circuitry for implementing a new code for calculating error detection bits for data. The code comprises multiple parts, each of which identifies the message data bits for calculating one of the error detection bits. Each of these parts of the code represents a rotation by the number of wires of at least one other of the parts. The consequence is that protection against burst errors across any particular wire is provided, with the code being less expensive in terms of the hardware required as compared to implementing a CRC.

Each of the parts of the code may comprise a plurality of subparts each of which is associated with one of a plurality of subsets of bits of the message data and identifies which bits of that subset are for use in calculating its associated one of the error detection bits. For each part of the code, each of the subparts of that part of the code may be given by a rotation by one of a corresponding subpart of another part of the code.

Each of the parts of the code may identify three bits from each of the plurality of subsets of the message data that are for use in calculating its associated one of the error detection bits.

The circuitry may be configured to cause the message data to be written to the memory device over a plurality of wires and in a plurality of data transfers, wherein each of the data transfers is associated with a different clock edge of a clock signal. The circuitry may be configured to cause the error detection bits to be written to the memory device. For each of the error detection bits: the respective one of the sets of bits between which XOR operations are performed to determine the respective error detection bit may comprise a number of subsets of bits each sent in a different one of the data transfers. For each of the data transfers, the respective subset of bits between which XOR operations are performed to determine the respective error detection bit may be sent over a same set of wires as a further subset of bits of the message data. The further subset of bits may be sent in a further one of the data transfers and belong to a further one of the sets of bits between which XOR operations are performed to generate a further one of the error detection bits.

The determining the plurality of error detection bits may comprise, for each of the bits of the message data: using the respective bit of the message data as an input to ones of the XOR operations to determine a respective set of three of the error detection bits. The sets of three error detection bits may be different for each of the bits of the message data.

The memory device may be an LPDDR chip.

The circuitry for causing the message data and the error detection bits to be sent to the memory device may comprise circuitry of the memory controller.

According to a second aspect, there is a device comprising circuitry for interfacing with a memory device over a plurality of wires, wherein the circuity is configured to: receive at least one write request comprising message data to be written to memory of the memory device; and determine a plurality of error detection bits for the message data in accordance with a code, wherein the code comprises a plurality of parts, each of which is associated with one of the error detection bits, wherein each of the parts of the code identifies which bits of the message data are for use in calculating its associated one of the error detection bits, wherein each of the parts of the code comprises a plurality of subparts each of which is associated with one of a plurality of subsets of bits of the message data and identifies which bits of that subset are for use in calculating its associated one of the error detection bits, wherein for each part of the code, each of the subparts of that part of the code are given by a rotation by one of a corresponding subpart of another part of the code, wherein the determining the plurality of error detection bits comprises, for each of the error detection bits: performing XOR operations between the bits of the message data that are identified based on the part of the code that is associated with the respective error detection bit, wherein the circuity is configured to: cause each of the plurality of the subsets of the message data to be sent to the memory device over a different one of the plurality of wires; and cause the error detection bits to be sent to the memory device.

Each of the parts of the code may identify three bits from each of the plurality of subsets of the message data for use in calculating its associated one of the error detection bits.

Further optional features of the second aspect are as defined hereinabove in relation to the first aspect, and may be combined in any combination. Furthermore, the features of the first aspect or third aspect may be made dependent on the second aspect.

According to a third aspect, there is a device comprising circuitry for interfacing with a memory device over a plurality of wires, wherein the circuity is configured to: receive at least one write request comprising message data to be written to memory of the memory device; and determine a plurality of error detection bits for the message data by, for each of the error detection bits: performing XOR operations between bits belonging to a respective one of a plurality of sets of bits of the message data, wherein the circuity is configured to: cause the message data to be written to the memory device over a plurality of wires and in a plurality of data transfers, wherein each of the data transfers is associated with a different clock edge of a clock signal; and cause the error detection bits to be written to the memory device, wherein, for each of the error detection bits: the respective one of the sets of bits between which XOR operations are performed to determine the respective error detection bit comprises a number of subsets of bits each sent in a different one of the data transfers; and for each of the data transfers, the respective subset of bits between which XOR operations are performed to determine the respective error detection bit are sent over a same set of wires as a further subset of bits of the message data, the further subset of bits being sent in a further one of the data transfers and belonging to a further one of the sets of bits between which XOR operations are performed to generate a further one of the error detection bits.

The determining the plurality of error detection bits may comprise, for each of the bits of the message data:
using the respective bit of the message data as an input to ones of the XOR operations to determine a respective set of three of the error detection bits,
wherein the sets of three error detection bits may be different for each of the bits of the message data.

The memory device may be an LPDDR chip.

The circuitry for causing the message data and the error detection bits to be sent to the memory device may comprise circuitry of the memory controller.

Further optional features of the third aspect are as defined hereinabove in relation to the first and second aspect, and may be combined in any combination. Furthermore, the features of the first aspect or second aspect may be made dependent on the third aspect.

According to a fourth aspect, there is a device comprising circuitry for interfacing with a memory device over a plurality of wires, wherein the circuity is configured to: receive from the memory device, a codeword comprising message data and associated error detection bits, wherein each of a plurality of the subsets of the message data are received from the memory device over a different one of the plurality of wires; determine a plurality of further error detection bits for the message data in accordance with a code, wherein the code comprises a plurality of parts each of which is associated with one of the further error detection bits; and check for errors in the message data by comparing the associated error detection bits to the further error detection bits, wherein each of the parts of the code identifies which bits of the message data are for use in calculating its associated one of the further error detection bits, wherein each of the parts of the code represents a rotation of another one of the parts of the code by a number of the plurality of the wires, wherein the determining the plurality of further error detection bits comprises, for each of the further error detection bits: performing XOR operations between the bits of the message data that are identified by the part of the code that is associated with the respective further error detection bit.

Each of the parts of the code may comprise a plurality of subparts each of which is associated with a different one of the plurality of subsets of bits of the message data and identifies which bits of that subset are for use in calculating the associated one of the further error detection bits. For each part of the code, each of the subparts of that part of the code may be represented by a rotation by one of a corresponding subpart of another part of the code.

The circuitry may be configured to receive from the memory device over the plurality of wires and a plurality of data transfers, message data belonging to the codeword, wherein each of the data transfers is associated with a different clock edge of a clock signal. The circuitry may be configured to determine the plurality of further error detection bits for the message data by, for each of the further error detection bits: performing XOR operations between bits belonging to a respective one of a plurality of sets of bits of the message data; and checking for errors in the message data by comparing the error detection bits to the further error detection bits. For each of the further error detection bits: the respective one of the sets of bits between which XOR operations are performed to determine the respective further error detection bit may comprise a number of subsets of bits each sent in a different one of the data transfer. For each of the data transfers, the respective subset of bits between which XOR operations are performed to determine the respective further error detection bit may be sent over a same set of wires as a further subset of bits of the message data. The further subset of bits may be sent in a further one of the data transfers and belong to a further one of the sets of bits between which XOR operations are performed to generate a further one of the further error detection bits.

Further optional features of the fourth aspect are as defined hereinabove in relation to the first to third aspects, and may be combined in any combination. Furthermore, the features of the fifth or sixth aspects may be made dependent on the fourth aspect.

According to a fifth aspect, there is a device comprising circuitry for interfacing with a memory device over a plurality of wires, wherein the circuity is configured to: receive from the memory device, a codeword comprising message data and error detection bits, wherein each of a plurality of the subsets of the message data are received from the memory device over a different one of the plurality of wires; determine a plurality of further error detection bits for the message data in accordance with a code, wherein the code comprises a plurality of parts, each of which is associated with one of the further error detection bits; and check for errors in the message data by comparing the error detection bits to the further error detection bits, wherein each of the parts of the code identifies which bits of the message data are for use in calculating its associated one of the further error detection bits, wherein each of the parts of the code comprises a plurality of subparts each of which is associated with a different one of the plurality of subsets of bits of the message data and identifies which bits of that subset are for use in calculating the associated one of the further error detection bits, wherein for each part of the code, each of the subparts of that part of the code are represented by a rotation by one of a corresponding subpart of another part of the code, wherein the determining the plurality of further error detection bits comprises, for each of the further error detection bits: performing XOR operations between the bits of the message data that are identified based on the part of the code that is associated with the respective further error detection bit.

Further optional features of the fifth aspect are as defined hereinabove in relation to the first to fourth aspects, and may be combined in any combination. Furthermore, the features of the fourth or sixth aspects may be made dependent on the fifth aspect.

According to a sixth aspect, there is a device comprising circuitry for interfacing with a memory device over a plurality of wires, wherein the circuity is configured to: receive from the memory device over the plurality of wires and a plurality of data transfers, message data belong to a codeword, wherein each of the data transfers is associated with a different clock edge of a clock signal; receive from the memory device, error detection bits belonging to the codeword; determine a plurality of further error detection bits for the message data by, for each of the further error detection bits: performing XOR operations between bits belonging to a respective one of a plurality of sets of bits of the message data, check for errors in the message data by comparing the error detection bits to the further error detection bits, wherein, for each of the further error detection bits: the respective one of the sets of bits between which XOR operations are performed to determine the respective further error detection bit comprises a number of subsets of bits each sent in a different one of the data transfers; and for each of the data transfers, the respective subset of bits between which XOR operations are performed to determine the respective further error detection bit are sent over a same set of wires as a further subset of bits of the message data, the further subset of bits being sent in a further one of the data transfers and belonging to a further one of the sets of bits between which XOR operations are performed to generate a further one of the further error detection bits.

Further optional features of the sixth aspect are as defined hereinabove in relation to the first to fifth aspects, and may be combined in any combination. Furthermore, the features of the fourth or fifth aspects may be made dependent on the sixth aspect.

All aspects as defined above may be combined in any combination. Any optional features defined in respect of the above aspects may be combined with any other of the aspects in any combination.

The present disclosure further extends to methods corresponding to the devices defined in the aspects above.

### BRIEF DESCRIPTION OF DRAWINGS

For a better understanding of the present invention to show how the same may be carried into effect, reference will now be made by way of example to the accompanying drawings:

FIG. 1 illustrates a system comprising a plurality of memory devices comprising memory to which a plurality of processing units have read and/or write access;

FIG. 2 illustrates a memory device and a device for interfacing with the memory device;

FIG. 3A illustrates message data of a codeword that is sent over an interface of the memory device;

FIG. 3B illustrates a check value that is sent over an interface of the memory device;

FIG. 3C illustrates message data comprising a number of errors occurring in a burst of the message data bits that are for transmission over a given bit position of the interface of the memory device;

FIG. 3D illustrates message data of a codeword, where the codeword comprises three erroneous message data bits;

FIG. 4A illustrates a first part of a code, where the first part identifies the bits of the message data that are used to calculate a first error detection bit for the message data;

FIG. 4B illustrates a second part of the code, where the second part identifies the bits of the message data that are used to calculate a second error detection bit for the message data;

FIG. 4C illustrates a third part of the code, where the third part identifies the bits of the message data that are used to calculate a third error detection bit for the message data;

FIG. 5A illustrates a portion of a first part of the code and a portion of the second part of the code;

FIG. 5B illustrates the rotation of respective subparts of different parts of the code;

FIG. 5C illustrates different parts of the code, each of which indicates the contribution of one of the message data bits to each of the error detection bits;

FIG. 6 illustrates part of a tree of XOR gates that is used to calculate one of the error detection bits;

FIG. 7 illustrates the relationship between different parts of the code;

FIG. 8 illustrates a method for writing data to the memory device; and

FIG. 9 illustrates a method for reading data from the memory device.

### DETAILED DESCRIPTION

Embodiments are implemented in a device for interfacing and permitting access to the memory of a memory device. In an example architecture, this device belongs to a chip and is arranged to process read and write requests originating from a processing unit.

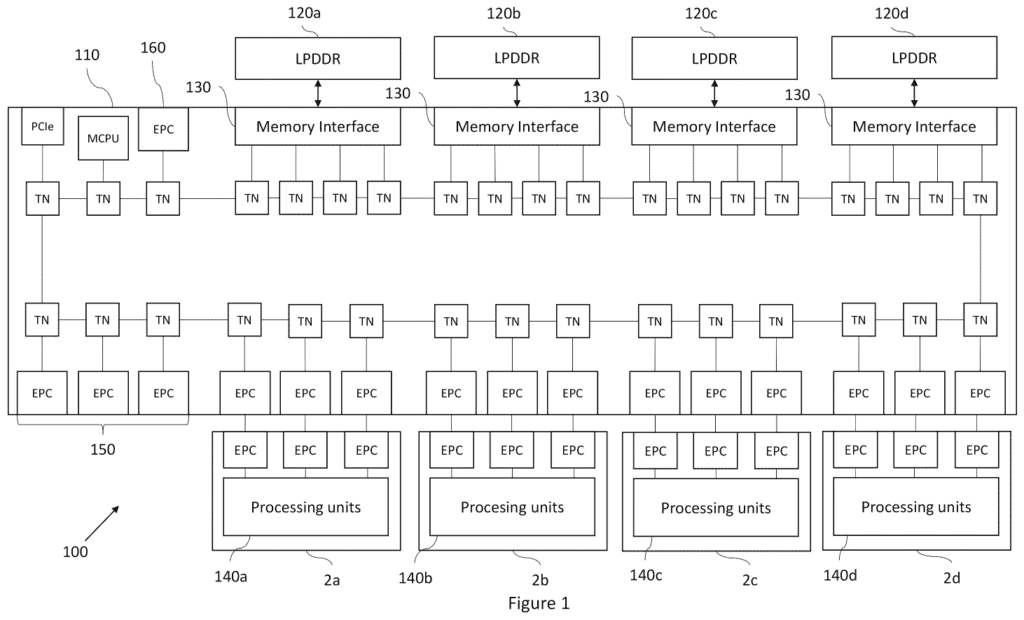

Reference is made to FIG. 1, which illustrates an example of a system 100 in which a number of instances of the device 130 are implemented as part of the chip 110. The chip 110, which may be referred to as a fabric chip 110, enables communication between the processing units 140 in the system 100 and other devices in the system 100. In particular, the fabric chip 110 enables a processing unit 140 to access memory of memory devices 120, to communicate with a host system via a PCIe interface, and to communicate with other processing units 140.

The system 100 comprises chips 2a-2d, each including one of the processing units 140a-d. Each of the processing units 140a-d comprises multiple tiles 4. In this case, references to operations (e.g., sending a read or write request) being performed by one of the processing units 140a-d are to be understood as being references to operations performed by a tile 4 of that processing unit 140.

The fabric chip 110 includes a number of interface controllers for communication with other chips (i.e., chips 2 or other instances of the fabric chip 110). These are shown in FIG. 1 as EPCs (‘Ethernet Port Controllers’) and provide for the dispatch of packets between chips in Ethernet frames. Each of the chips 2 also includes interface controllers for communicating with the fabric chip 110. As shown, each chip 2a-2d has multiple interface controllers for communicating with the fabric chip 110, which permits multiple tiles 4 of a processing unit 140a-d to send or receive data with the fabric chip 110 at the same time. In addition to the EPCs for communicating with the attached chips 2a-d, the fabric chip 110 further comprises a set of EPCs 150 for communicating with other fabric chips within a group (a ‘POD’) of chips, and an EPC 160 for connection to external Ethernet switches of an Ethernet network, enabling different groups of chips 2 to communicate in order to scale the system.

The fabric chip 110 comprises a network on chip (NOC) for transferring packets between the different interfaces of the chip 110. In embodiments, the NOC is a circular interconnect comprising a plurality of interconnected trunk nodes, which are each labelled ‘TN’ in FIG. 1. Packets traverse the interconnect, by passing from one trunk node to the next, where they are subject to arbitration and routing at each trunk node.

FIG. 1 shows a number of memory devices 120a-d connected to the fabric chip 110. In the example embodiment shown in FIG. 1, each of the memory devices 120a-d comprises Low-Power Double Data Rate (LPDDR) memory. However, a different type of memory could be used. In the example embodiment shown in FIG. 1, the fabric chip 110 comprises a plurality of interfaces 130 between the trunk nodes and the memory devices 120a-d. Each of the devices 130 provides an interface, enabling the processing units 140 to access the memory devices 120. The interface devices 130 receive memory read and write request packets originating from the processing units 140, where those requests are to read or write from the memory of their associated memory devices 120. In response to the read requests, the interface devices 130 return read completions containing the requested data. Each of the interface devices 130 contains circuitry for determining the error detection bits for data to be written to the respective memory device 120 and for determining the error detections bits for data read from the respective memory device 120.

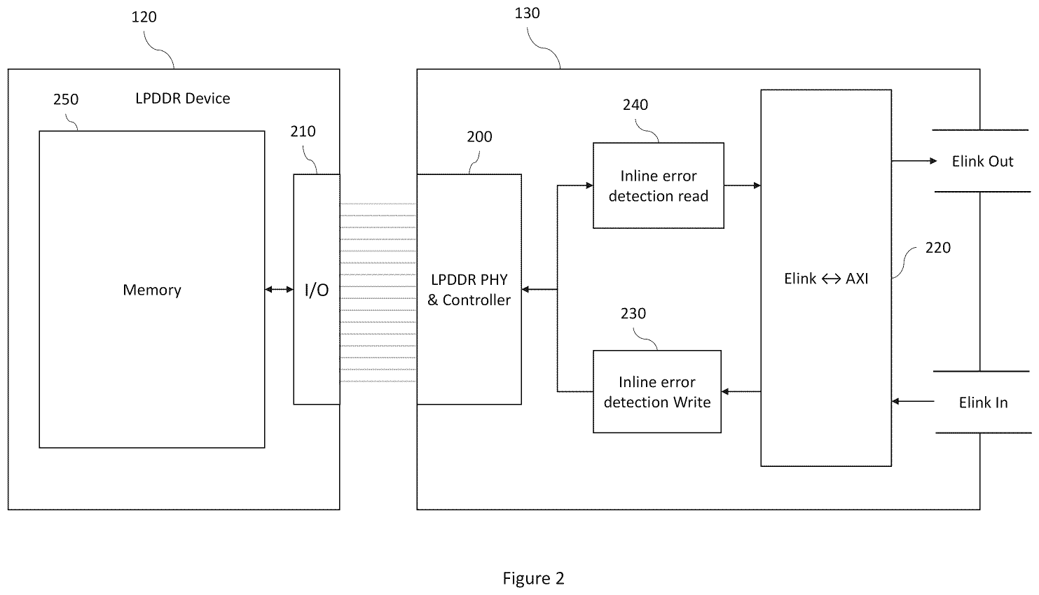

Reference is made to FIG. 2, which illustrates an interface device 130 and an associated memory device 120. The interface device 130 may be one of the memory interfaces 130 shown in FIG. 1, and the memory device 120 may be any of the memory devices 120a-d shown in FIG. 1.

FIG. 2 illustrates certain components within the interface device 130 for handling read and write requests originating from processing units 140. The interface device 130 has an input interface (shown as ‘Elink In’) for receiving read and write requests originating from a processing unit 140. The read and write requests may originate from one of the processing units 140a-140d attached to the chip 110 or from a processing unit 140 attached to another fabric chip. The interface device 130 receives the read and write request from the trunk node to which it is attached. The interface device 130 has an output interface (shown as ‘Elink out’) for outputting read completions from the interface device 130. The read completions are sent to the processing unit 140 from which a corresponding read request originated.

The read requests, write requests, and read completions take the form of packets. The packets, which may be referred to as Elink packets, are in a format suitable for transmission around the interconnect formed on the fabric chip 110. The interface device 130 includes protocol conversion circuitry 220, which converts the memory read or write request from the Elink protocol (used for data plane traffic on the fabric chips) to the AXI protocol, which is suitable for being provided to the memory device 120 for causing the write or read of data to be affected. The protocol conversion circuitry 220 also converts a read completion from the AXI protocol to the Elink protocol, so that it is then suitable for being output from the memory device 120 for delivery to one of the processing units 140.

A write request, after being processed by the protocol conversion circuitry 220, is provided to the check value calculation circuitry 230, which calculates the error detection bits based on the message data contained in the write request. A set of error detection bits (which may otherwise be referred to as the check value) are calculated over the set of message data bits in request and combined with the set of message data bits to provide a codeword. In embodiments, each codeword comprises 256 bits of message data and a 16-bit check value.

After the error detection bits have been calculated by the circuitry 230, the set of message data along with its associated error detection bits are provided by a memory controller 200 to the memory device 120. This data is received at the memory device 120 at interface 210 and is stored in the memory 250 of memory device 120. The memory device 120 comprises an interface 210 that has a predefined width, such that it can receive a certain number of bits in parallel. The width defines the number of bits that can be transported over the interface 210 on a single edge of the clock signal. In embodiments, the number of bits that can be transported over the interface 210 in parallel is 16 bits. A number of wires for transporting the data to be written to the memory 250 extend between the memory device 120 and the interface device 130. The number of wires (i.e., 16) is equal to the width of the interface 210 of the memory device. Each codeword that is written to the memory device 120 is spread temporally over multiple data transfers. In other words, each codeword is written over the interface 210 in a number of data transfers that each take place on a different clock edge of the clock signal. Each of these data transfers is referred to as a beat.

In the case of a read request, after the read request has been processed by the protocol conversion circuitry 220 to convert it to the AXI protocol, the read request is dispatched to the memory device 120. The data is retrieved from the memory device 120 and returned to the memory controller 200 over the interface 210. The data read from the memory 250 also takes the form of message data and associated error detection bits. A codeword comprising a set of message data and its associated error detection bits is provided over the interface 210 and over the wires connecting the memory device 120 with the interface device 130. As for the write data discussed above, the data read from the memory 250 is provided over the interface 210 and wires in a series of beats.

The codeword from the memory 250 is received at the memory controller 200, from where it is provided to the error check circuitry 240. The error check circuitry 240 computes the expected error detection bits based on the set of message data received from the memory device 120. The expected error detection bits are calculated by error check circuitry 240 using the same code to select message data bits as is used by the circuitry 230 to calculate the original error detection bits for message data to be written to the memory 250. Having calculated the expected error detection bits, the circuitry 240 then compares the error detection bits read from the memory 250 to the calculated expected error detection bits. If there is a mismatch, this indicates that one or more errors are present in either the message data or the error detection bits. If there is no mismatch, the message data is dispatched from the interface device 130 in a read completion to the processing unit 140 that issued the read request.

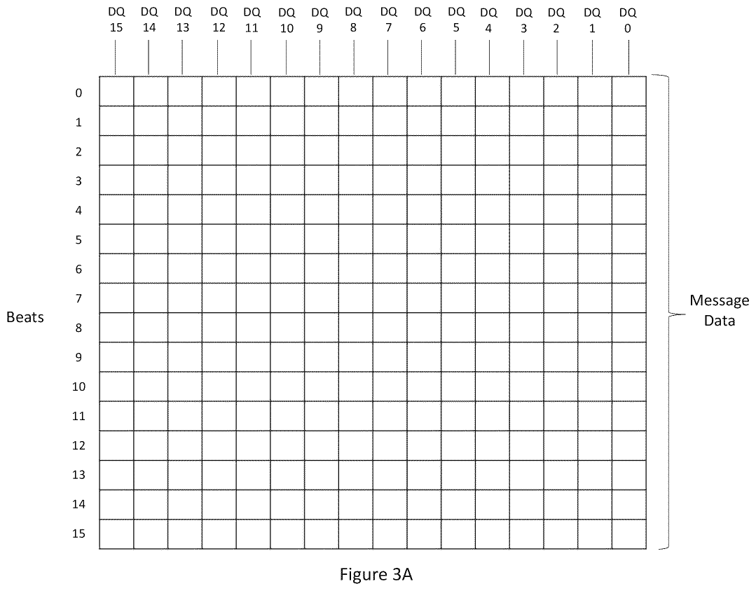

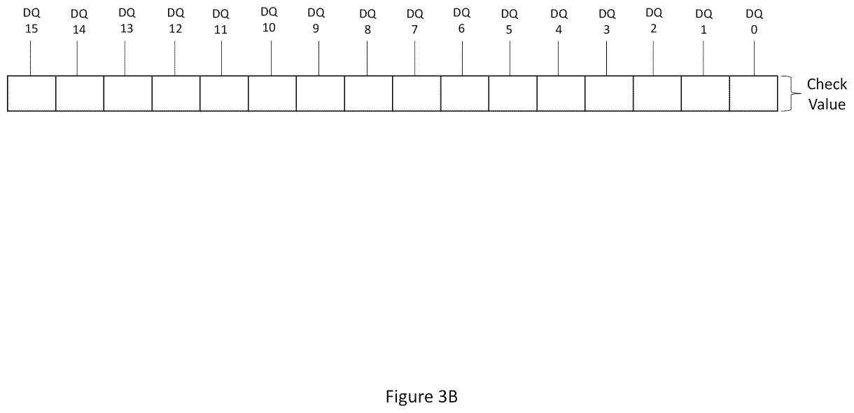

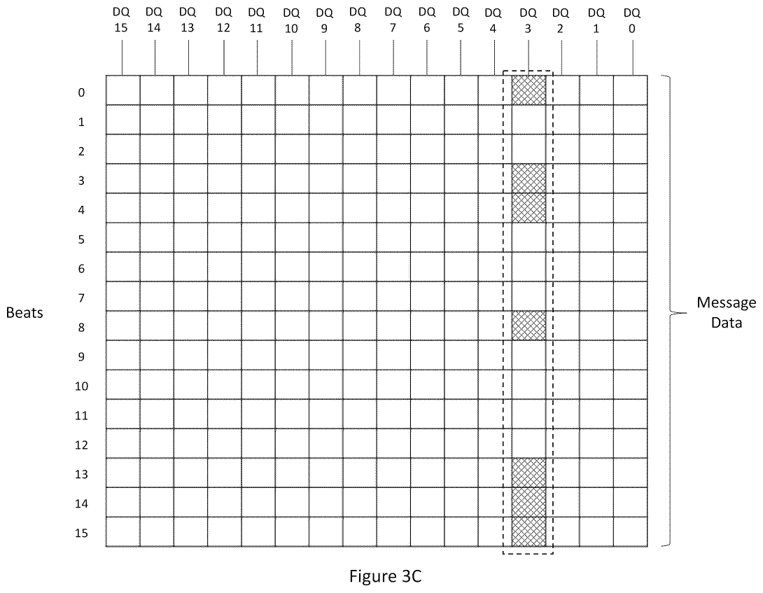

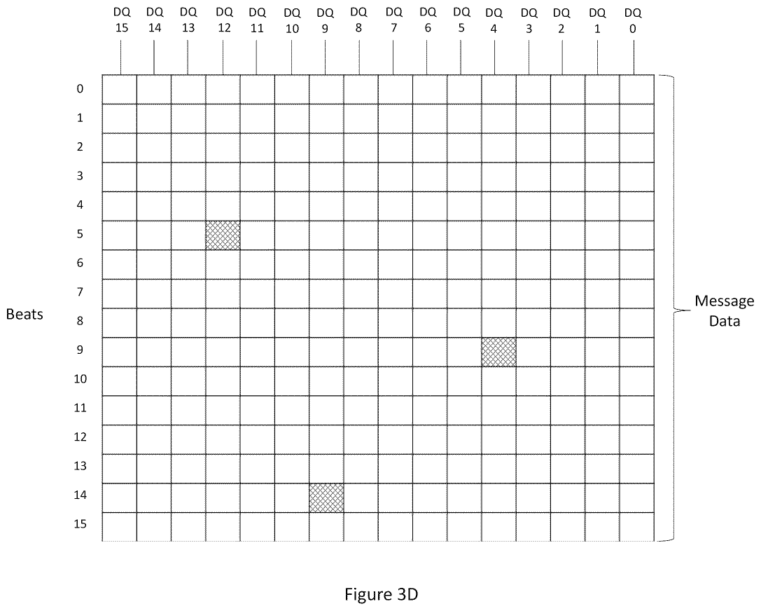

Reference is made to FIG. 3A, which illustrates an example of a set of message data belonging to a codeword. In this example, the set of message data comprises 256 bits.

The message data is arranged into columns, where each of the columns is associated with one of the wires (labelled DQ0 to D15) connecting the interface device 130 to the memory device 120. Each of the message data bits in a given column is transmitted over the wire associated with that column. The message data is also arranged into rows, where each of the rows is associated with a different beat in which the data is transmitted over the interface 210.

The check value is also sent by the memory controller 200 over the wires (labelled DQ0 to DQ15) and over the interface 210 to be stored in the memory 250 of the memory device 120. Reference is made to FIG. 3B, which shows the check value being transmitted in one of the beats. The check value is spread across the wires, such that each of the error detection bits is sent over a different wire. In example embodiments, the check value for a codeword is sent to the memory device 120 in a beat that precedes the sending of the corresponding message data belonging to the same codeword.

According to embodiments of the application, the check value is calculated according to a code that indicates which of the message data bits contribute to each error detection bit. A set of the message data bits contribute to an error detection bit if they are XORed together in order to calculate that error detection bit. The code comprises a plurality of parts, where each part indicates which message data bits are to be XORed together to calculate an associated error detection bit. Each of the plurality of parts is a rotation of another one of the plurality of parts, where the magnitude of the rotation is equal to the number of wires over which the message data bits are sent.

The new code is embodied in the arrangement of circuitry in the hardware blocks 230 and 240. This circuitry determines which message data bits are supplied as inputs to the XOR gates.

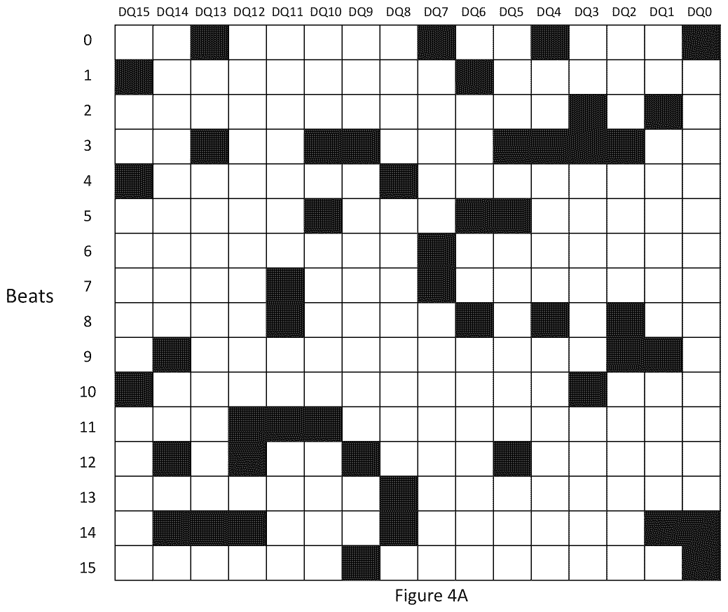

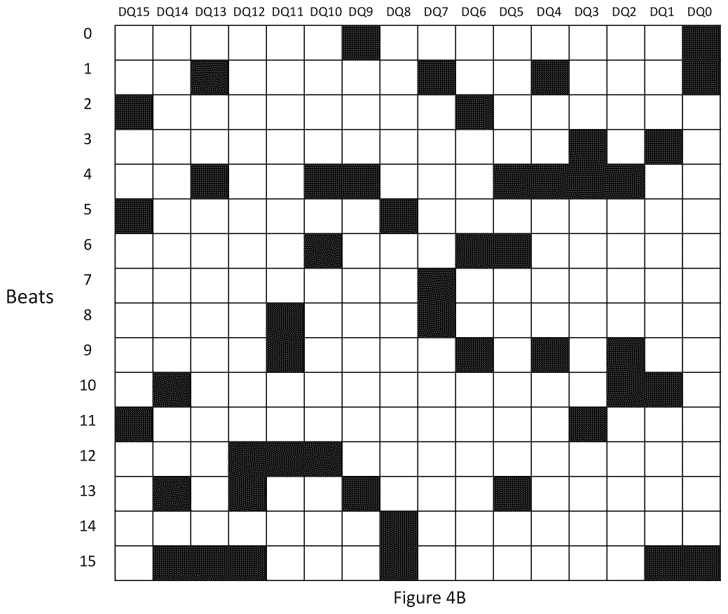

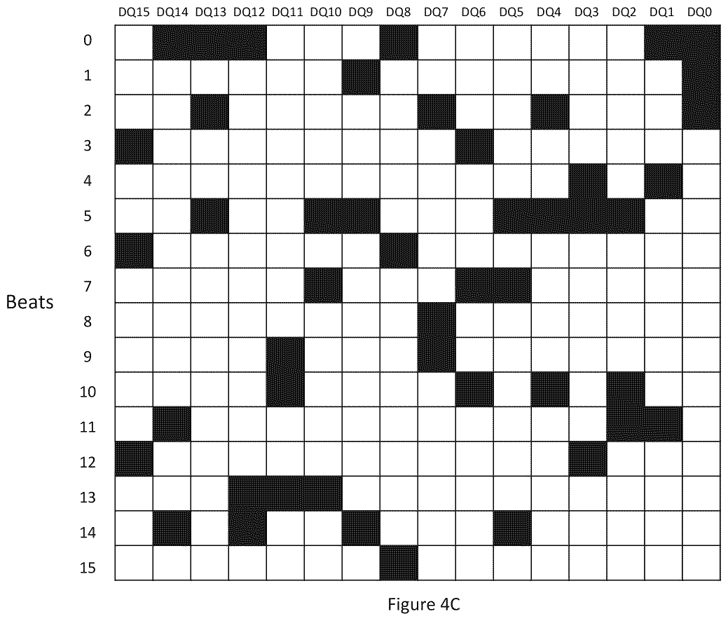

Reference is made to FIG. 4A, which illustrates an example of a part of the code that is used for calculating a first error detection bit of the check value. This part of the code indicates which of the bits of the message data are XORed together in order to determine the first bit of the check value. For example, the Figure indicates that the first error detection bit is calculated by XORing together the data bit sent over DQ0 in beat 0, the data bit sent over DQ0 in beat 14, the data bit sent over DQ0 in beat 15, the data bit sent over DQ1 in beat 2, etc.

As is apparent from FIG. 4A, the first error detection bit is computed based on three bits that are sent over each wire. For example, three of the bits (in beats 0, 14, 15) sent over DQ0 are used for calculating the first error detection bit, three of the bits (in beats 2, 9, 14) sent over DQ1 are used for calculating the first error detection bit, etc. In total, 48 bits of the message data are XORed together to generate the first error detection bit.

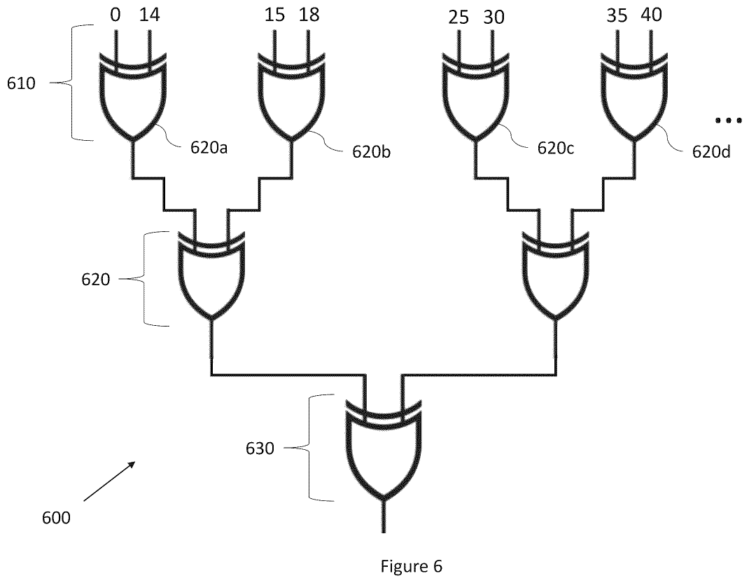

Reference is made to FIG. 6, which illustrates part of a tree of XOR gates 600 that are used to produce the first error detection bit. The tree of XOR gates 600 is part of the error detection bit calculation circuitry 230 and the error detection bit check circuitry 240. At a first stage 610 of the tree 600, the message data bits are input to XOR gates belonging to the first stage 610. The message data bits that are input to the XOR gates are selected in accordance with the first part of the code that is represented in FIG. 4A and that is used for determining the first error detection bit. Circuitry belonging to the calculation circuitry 230 and check circuitry 240 is configured to direct each of the message data bits to the appropriate XOR gate inputs in accordance with the first part of the code in order to calculate the first error detection bit. For example, first XOR gate 620a receives as inputs, message data bits 0 and 14 (which are sent over wire DQ0 in beats 0 and 14). The second XOR gate 620b receives as inputs, message data bits 15 (which is sent over DQ0 in beat 15) and 18 (which is sent over DQ1 in beat 2). The third XOR gate 620c receives as inputs, message data bits 25 (which is sent over DQ1 in beat 9) and 30 (which is sent over DQ1 in beat 14). The fourth XOR gate 620d receives as inputs, message data bits 35 (which is sent over DQ2 in beat 3) and 40 (which is sent over DQ2 in beat 8).

The outputs of the first stage of XOR gates 610 are provided to a second stage of XOR gates 620. Each XOR gate belonging to the second stage 620 receives as inputs, outputs from two XOR gates belonging to the first stage 610. Each XOR gate belonging to the third stage 630 receives as inputs, outputs from two XOR gates of the second stage 620. Only part of the tree 600 is shown in FIG. 6, but the full tree 600 may comprise 6 stages of XOR gates, in order to XOR together 48 message data bits and provide as an output, the first error detection bit.

FIG. 6 shows some of the message data bits used for calculating the first error detection bit. Each of the other error detection bits are calculated using a tree of XOR gates 600. For each of the other error detection bits, the message data bits input into the first stage 610 of the XOR tree are determined based on the respective part of the code for calculating that error detection bit. For each of the error detection bits, circuitry belonging to the calculation circuitry 230 and check circuitry 240 is configured to direct ones of the message data bits to the appropriate inputs of a XOR tree in accordance with the associated part of the code in order to calculate the respective error detection bit.

The second part of the code, which indicates which message data bits contribute to the calculation of the second error detection bit, is represented by a rotation of the first part of the code by the number of wires (i.e., 16 in the examples described herein) over which the message data bits are sent.

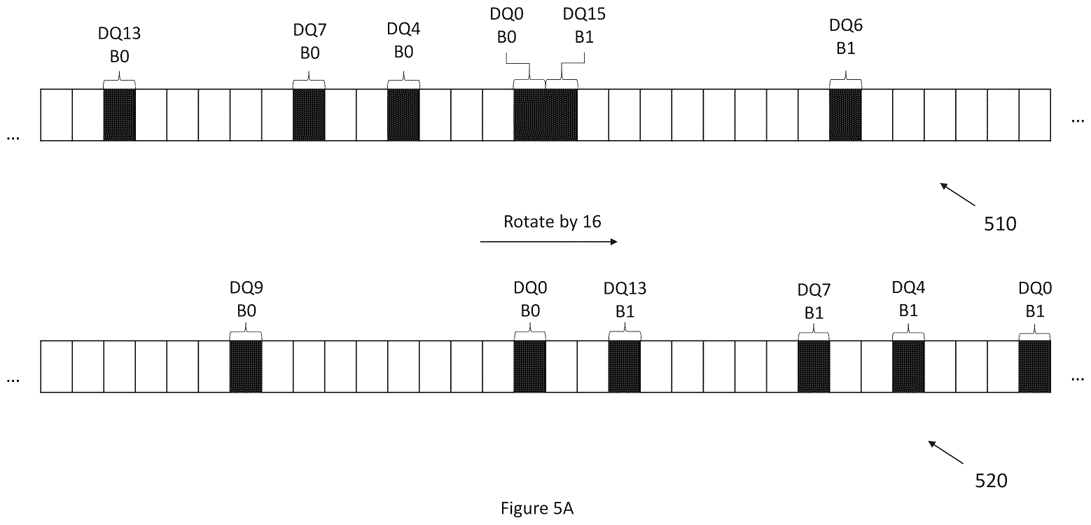

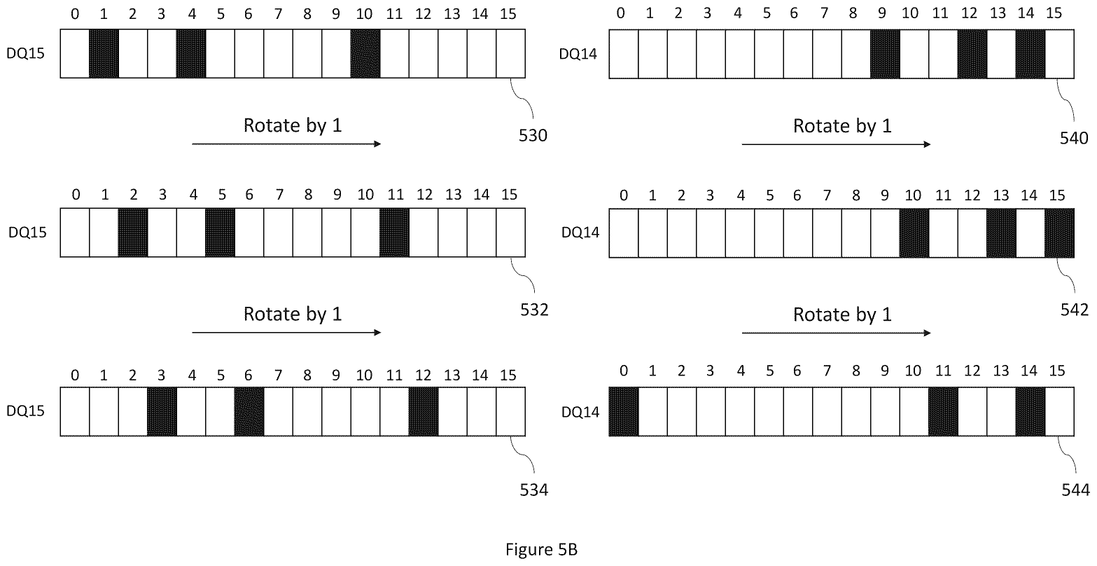

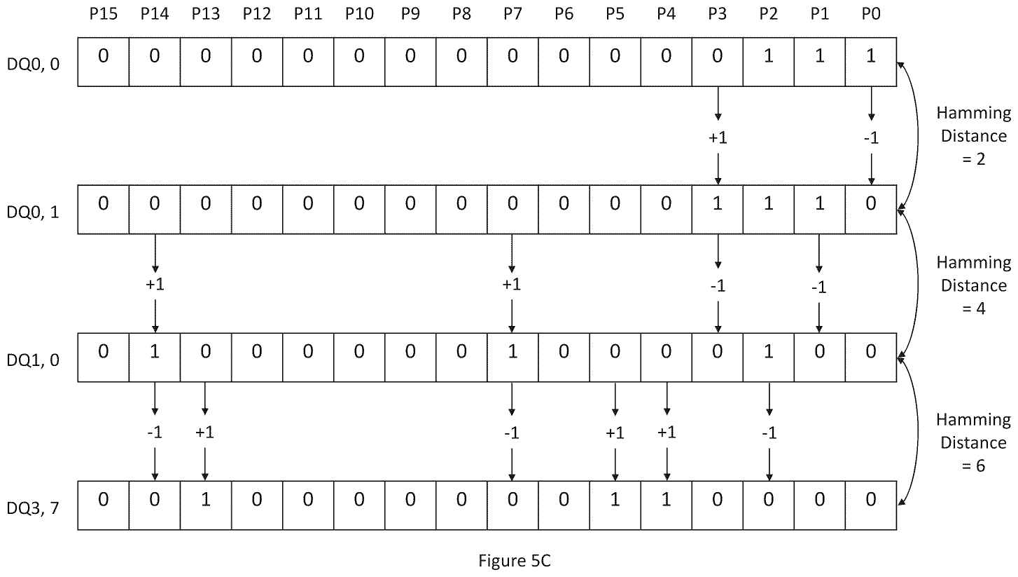

Reference is made to FIG. 5A, which illustrates how a first part of the code is rotated by 16 bits to produce the second part of the code. Shown in FIG. 5A is a portion 510 of the first part of the code. In FIG. 5A, each part of the code is illustrated as a continuous string in a single row in which each of the bits sent over the same beat are arranged contiguously. The portion 510 shown indicates which bits of the message data (i.e., those sent over DQ13, DQ7, DQ4, DQ0) in beat 0 contribute to the calculation of the first error detection bit, and which bits of the message data (i.e., those sent over DQ15, DQ6) in beat 1 contribute to the calculation of the first error detection bit. Also shown in FIG. 5A is a portion 520 of the second part of the code, which is also illustrated as a continuous string in a single row. The portion 520 shown indicates which bits of the message data (i.e., those sent over DQ9, DQ0) in beat 0 contribute to the calculation of the second error detection bit, and which bits of the message data (i.e., those sent over DQ13, DQ7, DQ4, DQ0) contribute to the calculation of the second error detection bit.

The second part of the code is represented by a rotation by the number of wires (i.e., 16) of the first part of the code. The consequence, as is seen in FIG. 5A, is that the bits in beat 0 that contribute to the first error detection bit are transmitted on the same wires (i.e., DQ13, DQ7, DQ4, DQ0) as the bits in beat 1 that contribute to the second error detection bit. The bits in beat 0 that contribute to the second error detection bit are transmitted on the same wires (i.e., D9 and DQ0) as the bits in beat 15 (not shown in FIG. 5A) that contribute to the first error detection bit.

Reference is made to FIG. 4B, which provides an illustration of the entire second part of the code. The second part of the code indicates which message data bits contribute to the second error detection bit. As with the first part of the code, the second part of the code also identifies three bits of the message data sent over each wire.

As may be seen by comparing FIG. 4B to FIG. 4A, the second part of the code is a rotation by the number of wires of the first part of the code. This may otherwise be expressed by stating that, for each beat of the message data, the bits of that beat that contribute to the second error detection bit are sent over the same wires as the bits of another one of the beats that contribute to the first error detection bit. For each of the beats apart from beat 0, this other one of the beats is the preceding beat. For beat 0, the other one of the beats is beat 15. For example, as seen in FIG. 4A, the bits that contribute to the first error detection bit and that are sent in beat 0 are sent over DQ0, DQ4, DQ7, and DQ13. As is seen in FIG. 4B, the bits that contribute to the second error detection bit and that are sent in beat 1 are sent over DQ0, DQ4, DQ7, and DQ13.

Reference is made to FIG. 4C, which illustrates the third part of the code. The third part of the code indicates which message data bits contribute to the third error detection bit. The third part of the code identifies three bits of the message data sent over each wire that contribute to the third error detection bit.

As may be seen by comparing FIG. 4C to FIG. 4B, the third part of the code is a rotation by the number of wires of the second part of the code. This may otherwise be expressed by stating that, for each beat, the bits of that beat that contribute to the third error detection bit are sent over the same wires as the bits of another one of the beats that contribute to the second error detection bit. For each of the beats apart from beat 0, this other one of the beats is the preceding beat. For beat 0, the other one of the beats is beat 15.

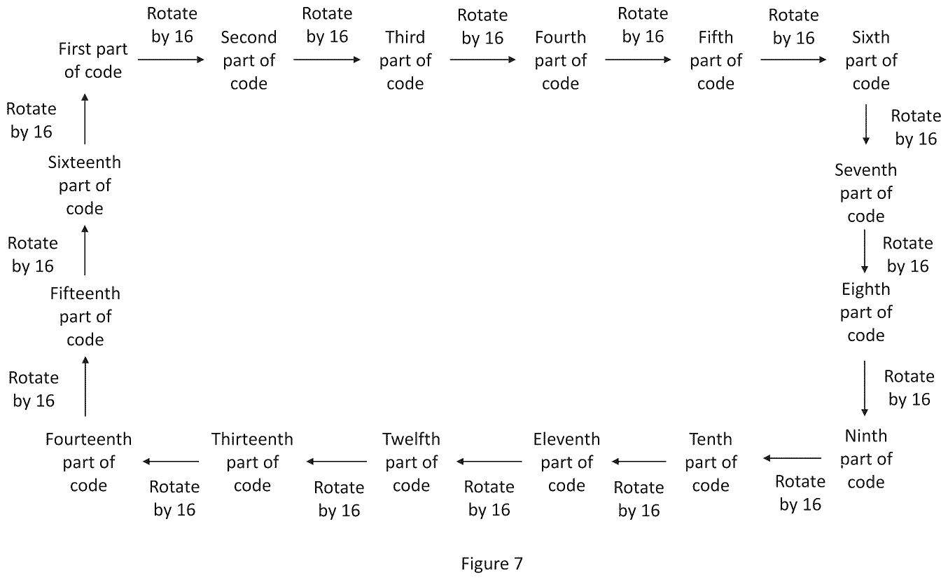

Reference is made to FIG. 7, which illustrates the relationship between each of the parts of the code. The number of parts of the code is equal to the number of error detection bits (i.e., 16 in this example) in a codeword.

As shown in FIG. 7, each part of the code is given by the rotation of another part of the code by the number of wires over which the message data is transmitted.

This condition may otherwise be expressed that for each error detection bit, for each beat, the message data bits of that beat that contribute to the respective error detection bit are sent over the same wires as the bits of another one of the beats that contribute to another one of the error detection bits. For each of the error detection bits apart from the first error detection bit, the other one of the error detection bits is the preceding error detection bit. For the first error detection bit, the other one of the error detection bits is the sixteenth error detection bit.

Furthermore, the condition may also be expressed in terms of rotations of bits belonging to subparts between different parts of the code. Reference is made to FIG. 5B, which illustrates different subparts of the code. A first subpart 530 belongs to the first part of the code. A second subpart 532 belongs to the second part of the code. A third subpart 534 belongs to the third part of the code. Each of the subparts 530, 532, 534 identifies which of the message data bits sent over a given wire (i.e., wire DQ15 in this example) contribute to a different error detection bit. Subpart 530 identifies the bits (i.e., the bit sent in beats 1, 4, and 10) that contribute to the first error detection bit. Subpart 532 identifies the bits (i.e., the bits sent in beats 2, 5, and 11) that contribute to the second error detection bit. Subpart 534 identifies the bits (i.e., the bits sent in 3, 6, and 12) that contribute to the third error detection bit. Subpart 532 represents a rotation by one of subpart 530. Likewise, subpart 534 represents a rotation by one of subpart 532. Therefore, it may generally be said that each of the subparts of the code that are associated with the same subset of message data bits (i.e., those message data bits for transmission over the same wire) are represented by a rotation by one of another subpart of the code that is associated with the same subset of message data bits.

In addition to the example of subparts 530, 532, 534 that are associated with the same wire DQ15, FIG. 5B shows further subparts 540, 542, 544 that are associated with wire DQ14.

The new code provides produces check values that protect against different types of errors. In particular, the check values generated using the new code are guaranteed to detect all errors occurring in a burst of message data bits that are transmitted over the same wire. Reference is made to FIG. 3C, which illustrates how a number of errors have occurred in bits transmitted over wire DQ3. These errors may result from a hardware fault that causes errors at this particular bit position, causing many of the bits sent over wire DQ3 to be flipped. As a result of the code described above, it is not possible for the effect of the errors on the check value to cancel with respect to one another.

The relationship between the different parts of the code guarantees detection of a burst of errors over a wire. Additionally, if the code is chosen such each message data bit contributes to a unique set of three error detection bits, then protection against three-bit errors anywhere in the message data is also guaranteed.

Reference is made to FIG. 5C, which illustrate a number of different strings of the code and the hamming distance between certain pairs of the strings. Each of these strings of the code is a part of the code that is associated with a given one of the message data bits and indicates to which of the error detection bits the associated message data bit contributes. Each of these parts of the code is not to be confused with the parts of the code (shown in FIGS. 4A, 4B, and 4C) that are each associated one of the error detection bits.

FIG. 5C shows the part of the code (labelled as DQ0, 0) associated with the message data bit to be sent over DQ0 in beat 0. This message data bit is used as input in the calculation of error detection bits P0, P1, and P2. The Figure also shows the part of the code associated with the message data bit to be sent over DQ0 in beat 1. This message data bit is used as an XOR gate input in the calculation of error detection bits P1, P2, and P3. Since two of the bits (i.e., bits for P0 and P3) must be modified to transform the DQ0, 0 part of the code into the DQ0, 1 part of the code, the hamming distance between these two parts is two. The hamming distance between DQ0, 1 and another example part of the code (DQ1, 0, which is the part of the code associated with the message data bit sent over DQ1 in beat 0) is four. The hamming distance between DQ1, 0 and another example part of the code (DQ3, 7, which is the part of the code associated with the message data bit sent over DQ1 in beat 0) is six.

Given that each message data bit contributes to the calculation of three error detection bits, and given that each message data bit contributes to a unique set of three error detection bits, the hamming distance between any two of the strings of the code (e.g., DQ0, 0; DQ0, 1; DQ1, 0; DQ3, 7) will be a non-zero even number (i.e., either two, four or six).

Reference is made to FIG. 3D, which illustrates a set of message data in which three bits are erroneous. These three bits have been flipped (e.g., by radiation) to take a different value since the error detection bits were generated. The three erroneous bits in FIG. 3D are the bits sent over DQ12 in beat 5, the bit sent over DQ4 in bit 9, and the bit sent over DQ9 in beat 14. As a result of the condition that, each of the three erroneous bits is covered by a unique set of three error detection bits, it is not possible for the errors to cancel without affecting the error detection bits. Therefore, detection of the error is guaranteed.

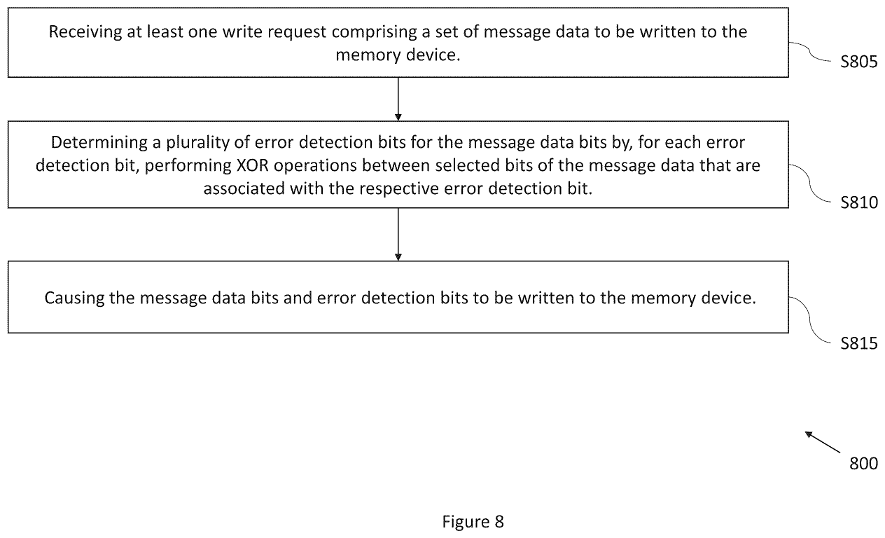

Reference is made to FIG. 8, which illustrates a method 800 for writing data to memory 250. The method 800 is implemented in the interface device 130.

At S805, the at least one write request comprising message data to be written to the memory device 120 is received. This at least one write request is received on the ‘Elink In’ interface of the device 130.

At S810, the error detection bits for the message data are calculated by the error detection bit generation circuitry 230. Each error detection bit is calculated by performing XOR operations between selected bits of the message data. The conditions for the selection of the bits of the message data may be expressed in different ways. The three different ways are given below.

Firstly, the error detection bits are calculated in accordance with a code, where the code comprises a plurality of parts, each of which is associated with one of the error detection bits. Each of the parts of the code identifies which bits of the message data are for use in calculating its associated one of the error detection bits, and represents a rotation of another one of the parts of the code by a number of the plurality of the wires. For each of the error detection bits, XOR operations are performed between the bits of the message data that are identified by the part of the code that is associated with the respective error detection bit.

Secondly, the error detection bits are calculated in accordance with a code, where the code comprises a plurality of parts, each of which is associated with one of the error detection bits. Each of the parts of the code identifies which bits of the message data are for use in calculating its associated one of the error detection bits. Each of the parts of the code comprises a plurality of subparts each of which is associated with one of a plurality of subsets of bits of the message data (each subset being for transmission over a different wire to the memory device 120) and identifies which bits of that subset are for use in calculating the associated one of the error detection bits. For each part of the code, each of the subparts of that part of the code are represented by a rotation by one of a corresponding subpart (that is associated with the same wire) of another part of the code. For each of the error detection bits, XOR operations are performed between the bits of the message data that are identified by the part of the code that is associated with the respective error detection bit.

Thirdly, the error detection bits are determined by, for each of the error detection bits, performing XOR operations between bits belonging to one of a plurality of sets of bits of the message data (each set is identified by a different one of the parts of the code). For each of the error detection bits: the respective one of the sets of bits between which XOR operations are performed to determine the respective error detection bit comprises a number of subsets of bits each sent in one of a number of data transfers (i.e., beats) occurring on a clock edge. For each of the beats, the respective subset of bits between which XOR operations are performed to determine the respective error detection bit are sent over a same set of wires as a further subset of bits, the further subset of bits being sent in a further one of the data transfers and belonging to a further one of the sets of bits between which XOR operations are performed to generate a further one of the error detection bits.

At S815, the message data bits and the error detection bits are written to the memory device 120 by memory controller 200.

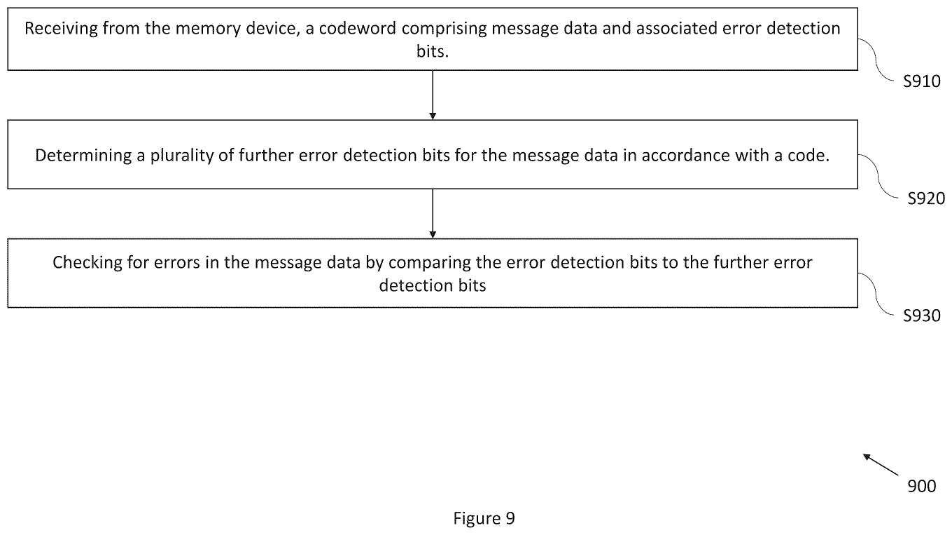

Reference is made to FIG. 9, which illustrates a method 900 for handling data read from memory 250. The method 900 is implemented in the interface device 130.

At S910, the memory controller 200 receives a codeword comprising message data and associated error detection bits from over the wires connecting it to the memory device 120.

At S920, the circuitry 240 calculates a set of further error detection bits in dependence upon the received message data. The further error detection bits are calculated in the same manner as the error detection bits calculated by circuitry 230 when data is written to the memory 250. The further error detection bits are calculated by performing XOR operations between selected bits of the message data. The conditions for the selection of the bits of the message data may be expressed in different ways, and in particular may be expressed in any of the three ways discussed above with respect to S810.

At S930, the circuitry 240 compares the further error detection bits calculated by circuitry 240 to the error detection bits in the data received from memory 250.

The above embodiments have been described by way of example only.

1. A device comprising circuitry for interfacing with a memory device over a plurality of wires, wherein the circuity is configured to:
receive at least one write request comprising message data to be written to memory of the memory device; and
determine a plurality of error detection bits for the message data in accordance with a code, wherein the code comprises a plurality of parts each of which is associated with one of the error detection bits,
wherein each of the parts of the code identifies which bits of the message data are for use in calculating its associated one of the error detection bits,
wherein each of the parts of the code represents a rotation of another one of the parts of the code by a number of the plurality of the wires,
wherein the determining the plurality of error detection bits comprises, for each of the error detection bits:
performing XOR operations between the bits of the message data that are identified by the part of the code that is associated with the respective error detection bit, wherein the circuity is configured to:
cause each of a plurality of subsets of the message data to be sent to the memory device over a different one of the plurality of wires; and
cause the error detection bits to be sent to the memory device.

2. The device of claim 1, wherein each of the parts of the code comprises a plurality of subparts each of which is associated with one of a plurality of subsets of bits of the message data and identifies which bits of that subset are for use in calculating its associated one of the error detection bits, and wherein for each part of the code, each of the subparts of that part of the code are given by a rotation by one of a corresponding subpart of another part of the code.

3. The device of claim 1, wherein each of the parts of the code identifies three bits from each of the plurality of subsets of the message data that are for use in calculating its associated one of the error detection bits.

4. The device of claim 1, wherein the circuity is configured to:
cause the message data to be written to the memory device over a plurality of wires and in a plurality of data transfers, wherein each of the data transfers is associated with a different clock edge of a clock signal; and
cause the error detection bits to be written to the memory device, wherein, for each of the error detection bits:
the respective one of the sets of bits between which XOR operations are performed to determine the respective error detection bit comprises a number of subsets of bits each sent in a different one of the data transfers; and
for each of the data transfers, the respective subset of bits between which XOR operations are performed to determine the respective error detection bit are sent over a same set of wires as a further subset of bits of the message data, the further subset of bits being sent in a further one of the data transfers and belonging to a further one of the sets of bits between which XOR operations are performed to generate a further one of the error detection bits.

5. The device of claim 1, wherein the determining the plurality of error detection bits comprises, for each of the bits of the message data:
using the respective bit of the message data as an input to ones of the XOR operations to determine a respective set of three of the error detection bits,
wherein the sets of three error detection bits are different for each of the bits of the message data.

6. The device of claim 1, wherein the memory device is an LPDDR chip.

7. The device of claim 1, wherein the circuitry for causing the message data and the error detection bits to be sent to the memory device comprises circuitry of the memory controller.

8. A device comprising circuitry for interfacing with a memory device over a plurality of wires, wherein the circuity is configured to:
receive from the memory device, a codeword comprising message data and associated error detection bits, wherein each of a plurality of the subsets of the message data are received from the memory device over a different one of the plurality of wires;
determine a plurality of further error detection bits for the message data in accordance with a code, wherein the code comprises a plurality of parts each of which is associated with one of the further error detection bits; and
check for errors in the message data by comparing the associated error detection bits to the further error detection bits,
wherein each of the parts of the code identifies which bits of the message data are for use in calculating its associated one of the further error detection bits,
wherein each of the parts of the code represents a rotation of another one of the parts of the code by a number of the plurality of the wires,
wherein the determining the plurality of further error detection bits comprises, for each of the further error detection bits:
performing XOR operations between the bits of the message data that are identified by the part of the code that is associated with the respective further error detection bit.

9. The device of claim 8, wherein each of the parts of the code comprises a plurality of subparts each of which is associated with a different one of the plurality of subsets of bits of the message data and identifies which bits of that subset are for use in calculating the associated one of the further error detection bits; and
.wherein for each part of the code, each of the subparts of that part of the code are represented by a rotation by one of a corresponding subpart of another part of the code.

10. The device of claim 8, wherein the circuity is configured to:
receive from the memory device over the plurality of wires and a plurality of data transfers, message data belonging to the codeword, wherein each of the data transfers is associated with a different clock edge of a clock signal;
determine the plurality of further error detection bits for the message data by, for each of the further error detection bits:
performing XOR operations between bits belonging to a respective one of a plurality of sets of bits of the message data,
checking for errors in the message data by comparing the error detection bits to the further error detection bits,
wherein, for each of the further error detection bits:
the respective one of the sets of bits between which XOR operations are performed to determine the respective further error detection bit comprises a number of subsets of bits each sent in a different one of the data transfers; and
for each of the data transfers, the respective subset of bits between which XOR operations are performed to determine the respective further error detection bit are sent over a same set of wires as a further subset of bits of the message data, the further subset of bits being sent in a further one of the data transfers and belonging to a further one of the sets of bits between which XOR operations are performed to generate a further one of the further error detection bits.

11. A method comprising:
receiving at least one write request comprising message data to be written to memory of a memory device; and
determining a plurality of error detection bits for the message data in accordance with a code, wherein the code comprises a plurality of parts each of which is associated with one of the error detection bits,
wherein each of the parts of the code identifies which bits of the message data are for use in calculating its associated one of the error detection bits,
wherein each of the parts of the code represents a rotation of another one of the parts of the code by a predefined number,
wherein the determining the plurality of error detection bits comprises, for each of the error detection bits:
performing XOR operations between the bits of the message data that are identified by the part of the code that is associated with the respective error detection bit, wherein the method comprises:
causing each of a plurality of subsets of the message data to be sent to the memory device over a different one of a plurality of wires, the plurality of wires consisting of the predefined number of wires; and
causing the error detection bits to be sent to the memory device.

12. The method of claim 11, wherein each of the parts of the code comprises a plurality of subparts each of which is associated with one of a plurality of subsets of bits of the message data and identifies which bits of that subset are for use in calculating its associated one of the error detection bits, and wherein for each part of the code, each of the subparts of that part of the code are given by a rotation by one of a corresponding subpart of another part of the code.

13. The method of claim 11, comprising causing the message data to be written to the memory device over a plurality of wires and in a plurality of data transfers, wherein each of the data transfers is associated with a different clock edge of a clock signal; and
causing the error detection bits to be written to the memory device, wherein, for each of the error detection bits:
the respective one of the sets of bits between which XOR operations are performed to determine the respective error detection bit comprises a number of subsets of bits each sent in a different one of the data transfers; and
for each of the data transfers, the respective subset of bits between which XOR operations are performed to determine the respective error detection bit are sent over a same set of wires as a further subset of bits of the message data, the further subset of bits being sent in a further one of the data transfers and belonging to a further one of the sets of bits between which XOR operations are performed to generate a further one of the error detection bits.

14. A method comprising:
receiving from a memory device, a codeword comprising message data and associated error detection bits, wherein each of a plurality of the subsets of the message data are received from the memory device over a different one of a plurality of wires;
determining a plurality of further error detection bits for the message data in accordance with a code, wherein the code comprises a plurality of parts each of which is associated with one of the further error detection bits; and
checking for errors in the message data by comparing the associated error detection bits to the further error detection bits,
wherein each of the parts of the code identifies which bits of the message data are for use in calculating its associated one of the further error detection bits,
wherein each of the parts of the code represents a rotation of another one of the parts of the code by a number of the plurality of the wires,
wherein the determining the plurality of further error detection bits comprises, for each of the further error detection bits:
performing XOR operations between the bits of the message data that are identified by the part of the code that is associated with the respective further error detection bit.

15. The method of claim 14 wherein each of the parts of the code comprises a plurality of subparts each of which is associated with a different one of the plurality of subsets of bits of the message data and identifies which bits of that subset are for use in calculating the associated one of the further error detection bits, and wherein for each part of the code, each of the subparts of that part of the code are represented by a rotation by one of a corresponding subpart of another part of the code.

16. The method of claim 14 comprising:
receiving from a memory device over a plurality of wires and a plurality of data transfers, message data belong to the codeword, wherein each of the data transfers is associated with a different clock edge of a clock signal;
determining the plurality of further error detection bits for the message data by, for each of the further error detection bits: performing XOR operations between bits belonging to a respective one of a plurality of sets of bits of the message data,
checking for errors in the message data by comparing the error detection bits to the further error detection bits,
wherein, for each of the further error detection bits:
the respective one of the sets of bits between which XOR operations are performed to determine the respective error detection bit comprises a number of subsets of bits each sent in one of the data transfers; and
for each of the data transfers, the respective subset of bits between which XOR operations are performed to determine the respective error detection bit are sent over a same set of wires as a further subset of bits of the message data, the further subset of bits being sent in a further one of the data transfers and belonging to a further one of the sets of bits between which XOR operations are performed to generate a further one of the error detection bits.
